(19) United States
(12) Patent Application Publication
(10) Pub. No.: US 2025/0178171 A1
(43) Pub. Date: Jun. 5, 2025

(54) Mainspring Disassembly Tool For Pistols

(71) Applicant: Victor Michael Cavola, Memphis, TN (US)

(72) Inventor: Victor Michael Cavola, Memphis, TN (US)

(21) Appl. No.: 19/048,299

(22) Filed: Feb. 7, 2025

(51) Int. Cl. B25B 27/30; F41A 35/00

(52) U.S. Cl. CPC B25B 27/304; F41A 35/00

(57) ABSTRACT

A mainspring disassembly tool for M1911-style semiautomatic pistol mainspring housings is disclosed, allowing the compression of the mainspring (a.k.a. hammer spring) to be easily and safely released and the retaining pin removed without the use of a bench vise. The mainspring disassembly tool is compact, and can be used with one hand, leaving the other hand free to remove or insert the retaining pin, making it suitable for use in the field. Disassembly, removal, installation, and reassembly of the mainspring from the mainspring housing can all be accomplished readily with only two hands.

### BACKGROUND OF THE INVENTION

Semiautomatic pistols patterned after the Colt .45 caliber model M1911, have a captive spring, usually called the mainspring (or hammer spring), which is under compression inside a housing, which forms part of the backstrap of the pistol's grip. The mainspring is held compressed within the mainspring housing between two parts, the mainspring cap, which sits atop the mainspring, and the mainspring retainer beneath. These parts are retained within the mainspring housing by a small retaining pin which is inserted through an aperture in the mainspring housing above the mainspring cap, holding it in place at one side, which keeps the mainspring under compression when assembled while still allowing access for the hammer strut which depresses the mainspring cap when the pistol's hammer is cocked, and which causes the hammer to strike when the trigger is pulled.

When disassembling the pistol for cleaning, removal of the mainspring from the mainspring housing is often skipped, because of the difficulty in safely and easily releasing the mainspring's compression, particularly in the field. A common method used to release the compression requires placing the mainspring housing in a bench vise so that one hand is available to depress the mainspring within the housing by applying pressure to the mainspring cap, while using the other to drive out the retaining pin with another tool. If the compression is released uncontrolledly, the mainspring cap and the mainspring could launch out of the housing. There is consequently a need for a tool which enables easy and controlled disassembly, removal, installation and reassembly of the mainspring within the mainspring housing without the need for a vise, and allows these procedures to be done in the field with only two hands.

### REFERENCE NUMBERS

100 Disassembly tool
110 Handle
115 Insert
120 Frame
125 Channels
130 Punch
132 Threads
134 Flange
136 Tip
200 Mainspring housing
202 Rails
204 Mainspring bore
210 Mainspring cap
215 Hammer strut seat
220 Mainspring
230 Mainspring retainer
240 Retaining pin

### BRIEF DESCRIPTION OF THE DRAWINGS

FIG. 1 is an exploded oblique front elevation view of a mainspring disassembly tool according to an embodiment of the invention.

FIG. 1a is an enlarged detail view of the punch of a mainspring disassembly tool according to an embodiment of the invention.

FIG. 2 is an assembled oblique front elevation view of a mainspring disassembly tool according to an embodiment of the invention.

FIG. 3 is an oblique front elevation view of a mainspring disassembly tool according to an embodiment of the invention, with a M1911-style mainspring housing inserted.

FIG. 3a is a cross sectional plan view sectioned along line i-i of FIG. 3 of a mainspring disassembly tool showing the offset d of the frame channels and the punch according to an embodiment of the invention, relative to the mainspring bore and rails of an inserted M1911-style mainspring housing.

FIG. 4 is a partial cutaway side elevation view sectioned along line ii-ii of FIG. 3 of a mainspring disassembly tool according to an embodiment of the invention, showing the interaction between the punch and the mainspring cap of an inserted M1911-style mainspring housing assembly.

FIG. 5 is a similar partial cutaway side elevation view to FIG. 4, showing the mainspring disassembly tool in use to depress the mainspring cap of an inserted M1911-style mainspring housing assembly so that the retaining pin can be removed.

FIG. 6 is an illustration of a mainspring disassembly tool according to an embodiment of the invention in the palm of user's hand being used to depress the mainspring cap of a M1911-style mainspring housing assembly using a gripping motion.

### DETAILED DESCRIPTION OF THE DRAWINGS

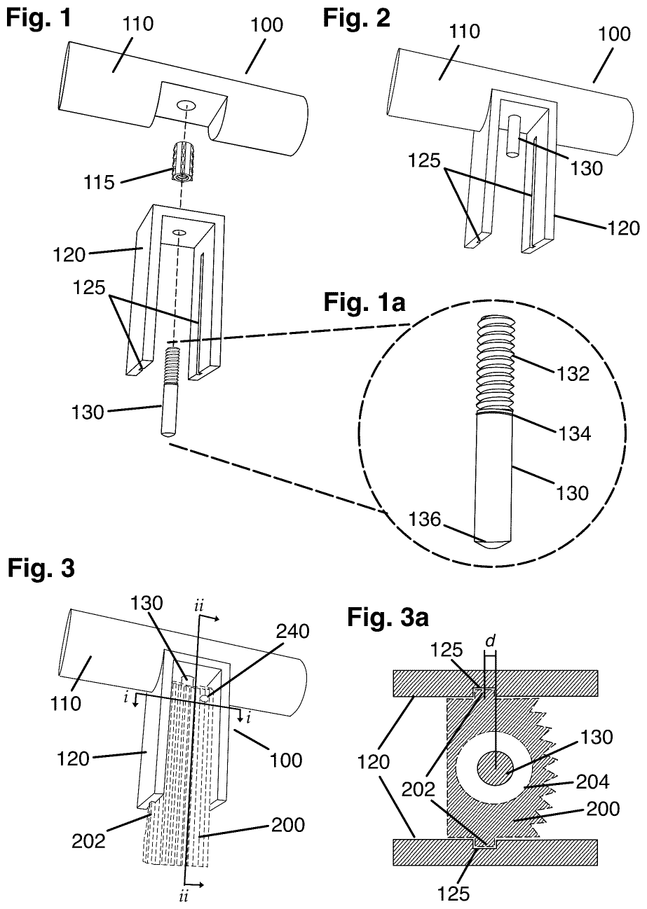

FIG. 1 is an exploded oblique front elevation view of a mainspring disassembly tool 100 according to an embodiment of the invention. In a preferred embodiment of the invention, a mainspring disassembly tool 100 comprises a handle 110, a generally U-shaped frame 120 having two parallel opposed channels 125 configured to accept the rails 202 of an inserted M1911-style mainspring housing assembly 200, and a punch 130 which is configured to be aligned with the mainspring bore 204 of an inserted M1911-style mainspring housing assembly 200. In a preferred embodiment, the punch 130 also serves as a fastener, and has threads 132 at one end which are screwed into threaded insert 115 in the handle 110 and serves to secure the frame to 120 the handle 110. In a preferred embodiment, the punch 130 may also include a flange 134 at the base of the threaded portion to hold the frame in compression against the handle 110, or the punch 130 may be tapered towards the tip 136 (not illustrated), with the portion adjacent to the threads 132 having a larger diameter to serve as a flange 134. In a preferred embodiment, the tip 136 of the punch may be conical or frustoconical in shape to complement the hammer strut seat 215 of the mainspring cap 210 of an inserted M1911-style mainspring housing assembly 200, or the tip may be hemispherical, or another suitable shape (not illustrated). In a preferred embodiment, the generally U-shaped frame 120, and the punch 130 are made from metal, and the handle 110 is generally cylindrical in shape and made of wood, and attached to the frame 120 in a “T” configuration. Alternatively, the handle 110 may be made of a suitable polymer or composite material, and the threaded insert 115 may be made of metal, a suitable polymer, or a composite material. Alternatively, a threaded socket may be formed integrally with the handle 110 and configured to accept the threads 132 of the punch 130, or the handle 110 may be overmolded onto a portion of the frame 120, and the frame provided with a threaded socket (not illustrated) configured to accept the threads 132 of the punch 130, or the mainspring disassembly tool 100 may be formed entirely and integrally from a suitable rigid material, such as metal, a polymer, or composite material.

FIG. 1a is an enlarged detail view of the punch 130 of a mainspring disassembly tool 100 according to an embodiment of the invention. The punch 130 is configured to be aligned with and inserted into the mainspring bore 204 of a M1911-style mainspring housing assembly 200, and to depress the mainspring cap 210, compressing the mainspring 220, and allowing the retaining pin 240 to be removed. In a preferred embodiment, the punch 130 also serves as a fastener, and has threads 132 at one end which are screwed into threaded insert 115 in the handle 110 and serves to secure the frame to 120 the handle 110. In a preferred embodiment, the punch 130 may also include a flange 134 at the base of the threaded portion to hold the frame in compression against the handle 110, or the punch 130 may be tapered towards the tip 136 (not illustrated), with the portion adjacent to the threads 132 having a larger diameter to serve as a flange 134. In a preferred embodiment, the tip 136 of the punch may be conical or frustoconical in shape to complement the hammer strut seat 215 of the mainspring cap 210 of an inserted M1911-style mainspring housing assembly 200, or the tip may be hemispherical, or another suitable shape (not illustrated). In a preferred embodiment, the punch 130 is made from metal, but it may also be made from a suitable rigid polymer or composite material.

FIG. 2 is an assembled oblique front elevation view of a mainspring disassembly tool 100 according to an embodiment of the invention. In a preferred embodiment the mainspring disassembly tool 100 is generally “T” shaped, comprising a handle 110, a generally U-shaped frame 120 having two parallel opposed channels 125 configured to accept the rails 202 of an inserted M1911-style mainspring housing assembly 200, and a punch 130 which is configured to be aligned with the mainspring bore 204 of a M1911-style mainspring housing assembly 200. The “T” shape enables the mainspring disassembly tool 100 and the inserted M1911-style mainspring housing assembly 200 to be gripped in the palm of a user's hand as illustrated in FIG. 6 and the handle 110 of the tool 100 squeezed by the user's fingers with a gripping motion to depress the mainspring cap 210, compressing the mainspring 220, and allowing the retaining pin 240 to be removed from the inserted M1911-style mainspring housing assembly 200.

FIG. 3 is an oblique front elevation view of a mainspring disassembly tool 100 according to an embodiment of the invention, with a M1911-style mainspring housing assembly 200 inserted. The two parallel opposed channels 125 of the frame 120 of a mainspring disassembly tool 100 according to the invention are configured to accept the rails 202 of a M1911-style mainspring housing assembly 200 which is inserted and slid into the tool 100, with the punch 130 coming to rest against the mainspring cap 210 within the mainspring bore 204. When an M1911-style mainspring housing assembly 200 is removed from the pistol, the top edge of the mainspring cap 210 rests against a small retaining pin 240, which maintains the mainspring under compression. To remove or insert the retaining pin 240, allowing disassembly or reassembly of the mainspring housing assembly 200, sufficient pressure must be applied to the mainspring cap 210 to depress it below the retaining pin 240, against the resistance to compression of the mainspring 220. The mainspring disassembly tool 100 of the present invention allows this to be done easily and safely, in a controlled manner, and without the use of a vise.

FIG. 3a is a cross sectional plan view sectioned along line i-i of FIG. 3 of a mainspring disassembly tool 100 showing the offset d of the centers of the channels 125 and the punch 130 according to an embodiment of the invention, relative to the mainspring bore 204 and rails 202 of an inserted M1911-style mainspring housing assembly. In a preferred embodiment, the punch 130 of a mainspring disassembly tool 100 according to the invention is substantially centered within the mainspring bore 204 by an offset d relative to the two parallel opposed channels 125 of the frame 120 into which the rails 202 of a M1911-style mainspring housing assembly 200 are inserted. The offset d is limited by the relative diameters of the punch 130 and the mainspring bore 204, and in a preferred embodiment is approximately 3/64ths of an inch, such that the tip 136 of the punch 130 is positioned against the hammer strut seat 215 of the mainspring cap 210, and substantially centered within the mainspring bore 204. While it is possible for a mainspring disassembly tool 100 according to the invention to function with an offset d of zero for certain diameters of punch 130 relative to the mainspring bore 204, such an offset may be undesirable due to lateral forces on the punch 130 and mainspring cap 210 causing possible damage or wear.

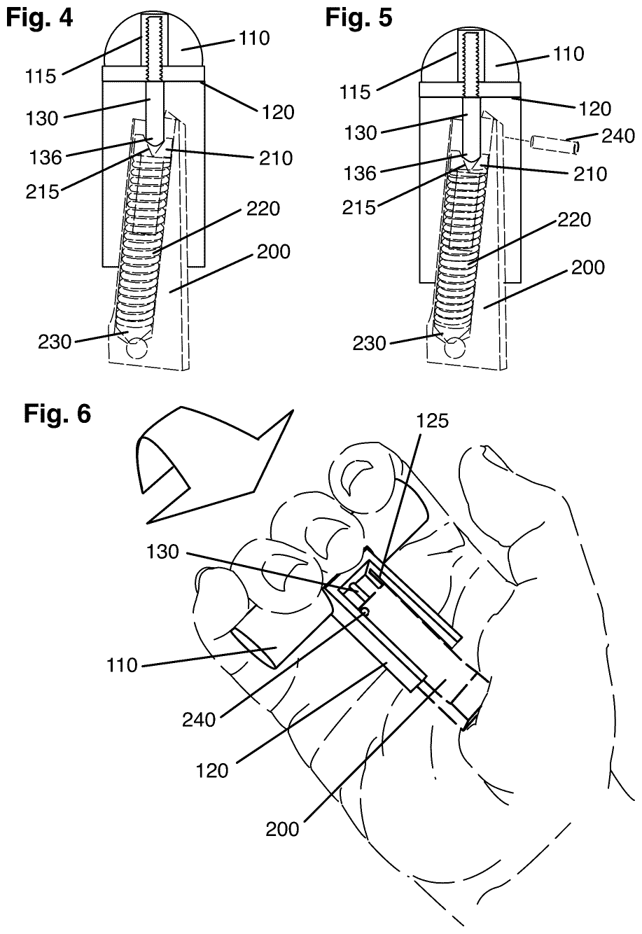

FIG. 4 is a partial cutaway side elevation view sectioned along line ii-ii of FIG. 3 of a mainspring disassembly tool 100 according to an embodiment of the invention, showing the interaction between the punch 130 and the mainspring cap 210 of an inserted M1911-style mainspring housing assembly 200. In a preferred embodiment, the tip 136 of the punch 130 is positioned against the hammer strut seat 215 of the mainspring cap 210 when a M1911-style mainspring housing assembly 200 is inserted into the disassembly tool 100, and the punch 130 is substantially centered within the mainspring bore 204. Applying pressure to the mainspring cap 210 compresses the mainspring 220 against the mainspring retainer 230.

FIG. 5 is a similar partial cutaway side elevation view to FIG. 4, showing the mainspring disassembly tool 100 in use to depress the mainspring cap 210 of an inserted M1911-style mainspring housing assembly 200 so that the retaining pin 240 can be removed. Applying pressure to the mainspring cap 210 compresses the mainspring 220 and permits the retaining pin 240 to be removed or inserted.

FIG. 6 is an illustration of a mainspring disassembly tool according to an embodiment of the invention in the palm of user's hand being used to depress the mainspring cap of a M1911-style mainspring housing assembly using a gripping motion. In a preferred embodiment, the generally cylindrical handle 110 of the mainspring disassembly tool 100 is attached to the frame 120 in a compact “T”-shaped configuration, allowing a M1911-style mainspring housing assembly 200 to be squeezed against the user's palm, leaving the user's other hand free to remove or insert the retaining pin 240 in an easy and controlled manner without the use of a vise. The compact size of the mainspring disassembly tool 100 according to the present invention makes it easily transportable for field use.

Although the invention has been shown and described with reference to certain specific presently preferred embodiments, the given embodiments should not be construed as limitations on the scope of the invention, but as illustrative examples, and those skilled in the art to which this invention pertains will undoubtedly find alternative embodiments obvious after reading this disclosure. With this in mind, the following claims are intended to define the scope of protection to be afforded the inventor, and these claims shall be deemed to include equivalent constructions insofar as they do not depart from the spirit and scope of the present invention.

We claim:

1. A mainspring disassembly tool comprising a handle, a generally U-shaped frame having parallel opposing inward-facing channels defining a plane, and a punch equidistant from said parallel opposing inward-facing channels wherein said punch is offset from said plane of said parallel opposing inward-facing channels by a distance, d, and has a first end and a second end.

2. The mainspring disassembly tool of claim 1, wherein said parallel opposing inward-facing channels are configured to accept the rails of a M1911-style mainspring housing.

3. The mainspring disassembly tool of claim 2, wherein said distance d is in the range of 0- 7/64ths of an inch.

4. The mainspring disassembly tool of claim 3, wherein said handle is generally cylindrical in shape and attached to said generally U-shaped frame in a perpendicular T-shaped configuration relative to said parallel opposing inward-facing channels.

5. The mainspring disassembly tool of claim 4, wherein said handle is attached to said generally U-shaped frame by an attachment means.

6. The mainspring disassembly tool of claim 5, wherein said frame further comprises a mounting hole, and said attachment means comprises a threaded insert in said handle, said first end of said punch comprising threads configured to be screwed into said threaded insert through said mounting hole in said frame and said punch further comprising a flange adjacent to said threads between said first end and said second end of said punch.

7. The mainspring disassembly tool of claim 6, wherein said second end of said punch further comprises a tip having a conical or frustoconical shape.

8. The mainspring disassembly tool of claim 6, wherein said second end of said punch further comprises a tip having a hemispherical shape.

9. The mainspring disassembly tool of claim 4, wherein said distance d is between 2- 3/64ths of an inch.

10. A mainspring disassembly tool comprising a generally cylindrical handle, attached in a perpendicular T-shaped configuration to a generally U-shaped frame having parallel opposing inward-facing channels defining a plane, and a punch equidistant from said parallel opposing inward-facing channels wherein said punch is offset from said plane of said parallel opposing inward-facing channels by a distance, d, and has a first end and a second end.

11. The mainspring disassembly tool of claim 10, wherein said parallel opposing inward-facing channels are configured to accept the rails of a M1911-style mainspring housing.

12. The mainspring disassembly tool of claim 11, wherein said distance d is in the range of 0- 7/64ths of an inch.

13. The mainspring disassembly tool of claim 12, wherein said generally cylindrical handle further comprises a threaded insert, said frame further comprises a mounting hole, and said first end of said punch comprises threads configured to be screwed into said threaded insert through said mounting hole in said frame.

14. The mainspring disassembly tool of claim 13, wherein said punch further comprises a flange adjacent to said threads between said first end and said second end of said punch.

15. The mainspring disassembly tool of claim 13, wherein said second end of said punch is tapered outward toward said threads.

16. The mainspring disassembly tool of claim 14, wherein said second end of said punch further comprises a tip having a conical or frustoconical shape.

17. The mainspring disassembly tool of claim 14, wherein said second end of said punch further comprises a tip having a hemispherical shape.

18. A mainspring disassembly tool comprising a generally cylindrical handle, attached in a perpendicular T-shaped configuration to a generally U-shaped frame having parallel opposing inward-facing channels defining a plane, and a punch equidistant from said parallel opposing inward-facing channels wherein said punch is offset from said plane of said parallel opposing inward-facing channels by a distance, d, and has a first end and a second end.

19. The mainspring disassembly tool of claim 18, wherein said parallel opposing inward-facing channels are configured to accept the rails of a M1911-style mainspring housing.

20. The mainspring disassembly tool of claim 19, wherein said distance d is between 2- 3/64ths of an inch.
